(19) United States
(12) Patent Application Publication
(10) Pub. No.: US 2025/0188247 A1
(43) Pub. Date: Jun. 12, 2025

(54) DISSOLUTION AND DEPOLYMERIZATION OF PLASTICS

(71) Applicants: THE REGENTS OF THE UNIVERSITY OF CALIFORNIA, Oakland, CA (US); NATIONAL TECHNOLOGY & ENGINEERING SOLUTIONS OF SANDIA, LLC, Albuquerque, NM (US)

(72) Inventors: Hemant CHOUDHARY, Emeryville, CA (US); Seema SINGH, Hayward, CA (US); John M. GLADDEN, Alameda, CA (US); Damian J. CARRIERI, Berkley, CA (US); Blake A. SIMMONS, San Francisco, CA (US)

(21) Appl. No.: 18/971,238

(22) Filed: Dec. 6, 2024

Related U.S. Application Data
(60) Provisional application No. 63/608,070, filed on Dec. 8, 2023.

(51) Int. Cl. C08J 11/28

(52) U.S. Cl. CPC C08J 11/28; C08J 2300/30

(57) ABSTRACT

The present invention provides for a method for depolymerizing a mixture of plastics, said method comprising: (a) providing a composition comprising a synthetic plastic polymer; (b) introducing an amine solvent compound to the composition to form a polymer-amine solvent composition, and (c) incubating the polymer-amine solvent composition for a period of time to produce a depolymerized composition such that at least a portions of the synthetic plastic polymer is depolymerized into monomers.

### CROSS-REFERENCE TO RELATED APPLICATIONS

This application claims priority to U.S. Provisional Patent Application Ser. No. 63/608,070, filed Dec. 8, 2023, which are hereby incorporated by reference.

### STATEMENT OF GOVERNMENTAL SUPPORT

The invention was made with government support under Contract Nos. DE-AC02-05CH11231 awarded by the U.S. Department of Energy. The government has certain rights in the invention.

### FIELD OF THE INVENTION

The present invention is in the field of recycling plastics.

### BACKGROUND OF THE INVENTION

The majority of the high market share plastics such as polyethylene (PE), polypropylene (PP), polyethylene terephthalate (PET), polystyrene (PS), polyvinylchloride (PVC), polyurethane (PUR) are procured from nonrenewable sources and are non-biodegradable. As a result, the world is now covered with non-biodegradable synthetic plastics, which mar our landscapes and threaten our oceans. At the same time, plastics represent a $654 billion market worldwide and are ubiquitous in modern life. Simply eliminating synthetic plastic with no viable alternatives would be almost impossible and catastrophic from both a social and economic point of view. The global leaders in academia, industry, and government has proposed plastic recycling as the solution to this issue and efforts have been made in this regard. But only 5% to 9% of the global synthetic plastic produced is being recycled effectively. Nonetheless, recycling plastics has its own challenges in the form of limited solubility in environmentally benign and economical media and intensive energy requirements; resulting in economic non-viability and loss in quality with every recycling process because of the oxidative degradation and structural changes (at higher temperatures).

Notably, the dissolution of plastics under mild conditions in relatively non-toxic, bio-compatible, and inexpensive, easy-to-handle solvents would be ideal in sustaining both plastic industry and environment from the social, economic, and ecological viewpoints. There is a critical need to develop a technology to reuse these synthetic plastics for re-entry into the sustainable chemical industry supply chain with minimum energy requirements.

Horn et a. (“Mechanisms of Organocatalytic Amidation and Trans-Esterification of Aromatic Esters As a Model for the Depolymerization of Poly(ethylene) Terephthalate”, J. Phys. Chem. 116:12389-12398, 2012) disclose 1,5,7-triazabicyclododecene (TBD)-catalyzed depolymerization of poly(ethylene) terephthalate (PET) with ethylene glycol (EG), ethylenediamine (EDA), and ethanolamine (EA).

Fukushima et al. (“Advanced Chemical Recycling of Poly(ethylene terephthalate) Through Organocatalytic Aminolysis”, Polymer Chem. 5, 2013) disclose organocatalysis of the aminolytic depolymerization of waste poly(ethylene terephthalate) (PET) using 1,5,7-triazabicyclo[4.4.0]dec-5-ene (TBD) as a necessary catalyst producing a broad range of crystalline terephthalamides.

### SUMMARY OF THE INVENTION

The present invention provides for a method for the dissolution and depolymerization of single and/or mixed non-biodegradable plastics. The present invention solves key-issues of plastic pollution and recycling.

The present invention provides for a composition comprising: (a) a plastic polymer, and (b) an amine solvent compound; wherein the composition is halogen or halide free. In some embodiments, the plastic polymer (or plastic) is a synthetic or natural polymer/polyester. In some embodiments, the composition comprises: (a) a plastic, or mixture thereof, is present in the amount of from about 0.1% to about 70%; (b) an amine, or mixture thereof, is present in the amount of from about 10% to about 99.9%; and, (c) water is present in the amount of from about 0.01% to about 50%. In some embodiments, the percentages are by weight or by volume.

In some embodiments, the composition has a temperature equal to or greater than about 25° C. or room temperature. In some embodiments, the composition has a temperature equal to or greater than about 30° C., 35° C., 40° C., 45° C., 50° C., or 55° C. In some embodiments, the amine solvent compound is primary amine, secondary amine, tertiary amine, quaternary amine, or a mixture thereof. In some embodiments, the amine solvent compound is an organic compound, or a mixture of organic compounds. In some embodiments, the amine solvent compound has about 1, 2, 3, 4, 5, 6, 7, 8, 9, or 10 carbon atoms, or is an organic compound having a number of carbon atoms within a range of any two preceding values. In some embodiments, the organic compound has about 1, 2, 3, 4, 5, 6, 7, 8, 9, or 10 amine functional groups. In some embodiments, the organic compound has about 2 or more amine functional groups. In some embodiments, the amine functional groups are not covalently bonded to the same carbon atom. In some embodiments, the amine solvent compound is a straight, branched, or cyclic alkane or aromatic with about 1, 2, 3, 4, 5, 6, 7, 8, 9, or 10 carbon atoms, and about 1, 2, 3, 4, 5, 6, 7, 8, 9, or 10 amine functional groups, or a mixture thereof. In some embodiments, the amine solvent compound is a straight or branched chain alkane, or a mixture thereof. In some embodiments, the amine solvent compound is an alkane with about 1, 2, 3, or 4 carbon atoms, or a mixture thereof. In some embodiments, the amine solvent compound is an alkane with about 1, 2, 3, or 4 amine functional groups, or a mixture thereof. In some embodiments, the amine solvent compound is a straight or branched chain alkane with about 1, 2, 3, or 4 carbon atoms, and about 1, 2, 3, or 4 amine functional groups, or a mixture thereof. In some embodiments, the amine solvent compound is ethaneamine, 1,1-ethanediamine, 1,2-ethanediamine, 1-propaneamine, 2-propaneamine, 1,1-propanediamine, 1,2-propanediamine, 1,3-propanediamine, 2,2-propanediamine, 1,1,1-propanetriamine, 1,1,2-propanetriamine, 1,2,2-propanetriamine, 1,1,3-propanetriamine, 1,2,3-propanetriamine, 1-butaneamine, 2-butaneamine, 1,1-butanediamine, 1,2-butanediamine, 1,3-butanediamine, 1,4-butanediamine, 2,2-butanediamine, 2,3-butanediamine, 1,1,1-butanetriamine, 1,1,2-butanetriamine, 1,1,3-butanetriamine, 1,1,4-butanetriamine, 1,2,2-butanetriamine, 1,2,3-butanetriamine, 1,2,4-butanetriamine, 1,3,3-butanetriamine, 2,2,3-butanetriamine, 1,1,1,2-butanetetraamine, 1,1,1,3-butanetetraamine, 1,1,1,4-butanetetraamine, 1,1,2,2-butanetetraamine, 1,1,2,3-butanetetraamine, 1,1,2,4-butanetetraamine, 1,1,3,4-butanetetraamine, 1,1,3,3-butanetetraamine, 1,2,2,3-butanetetraamine, 1,2,2,4-butanetetraamine, 1,2,3,3-butanetetraamine, 1,2,3,4-butanetetraamine, 2,2,3,3-butanetetraamine, benzenamine (aniline), benzene-1,2-diamine (1,2-diaminobenzene or o-phenylenediamine (OPD), benzene-1,3-diamine (1,3-diaminobenzene or m-phenylenediamine (MPD)), benzene-1,4-diamine (1,4-diaminobenzene or p-phenylenediamine (PPD)), or a mixture thereof.

In some embodiments, the amine solvent compound is a polyamine. In some embodiments, the amine solvent compound is a polyamine taught by U.S. Patent Application Publication No. 2022/0194877, hereby incorporated by reference in its entirety. In some embodiments, the polyamine has the chemical structure:

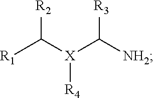

wherein X is CH or N; and R₁, R₂, R₃, and R₄, are each independently —H, —NH₂, alkyl, alkenyl, alkynyl, aryl, alkyl amine, alkenyl amine, alkynyl amine, or aryl amine.

In some embodiments, the polyamine comprises at least 2, 3, 4, or 5 N atoms or amines. In some embodiments, the polyamine comprises at least 2, 3, 4, 5, 6, 7, 8, 9, 10, 20, or 30 carbon atoms total, or having a longest chain having at least 2, 3, 4, 5, 6, 7, 8, 9, 10, 15, or 20 carbon or nitrogen atoms. In some embodiments, each alkyl, alkenyl, alkynyl, aryl, alkyl amine, alkenyl amine, alkynyl amine, or aryl amine independently comprises at least 1, 2, 3, 4, 5, 6, 7, 8, 9, or 10 carbon atoms total, or has a longest chain having at least 1, 2, 3, 4, 5, 6, 7, 8, 9, or 10 carbon or nitrogen atoms.

In some embodiments, the polyamine is a diamine, triamine, 1,5-diaminopentane, 1,4-diaminobutane, 1,3-diaminopropane, 1,2-diaminoethane, 1,2-diaminopropane, and 1,4-diaminobutane, ethylenediamine (ethane-1,2-diamine), diethylenetriamine, 1,3-diaminopropane (trimethylenediamine), 1,4-diaminobutane (putrescine), 1,5-diaminopentane (cadaverine), 1,2-diaminopropane, spermine (N1,N1′-(butane-1,4-diyl)bis(propane-1,3-diamine)), spermidine (N1-(3-aminopropyl) butane-1,4-diamine), 2,2-dimethyl-1,3-propanediamine, or any one of the following polyamines shown in Table 1, or a mixture thereof.

TABLE 1
Polyamines suitable for use in the invention

| Chemical Name | Chemical Structure |
|---|---|
| diethylenetriamine | 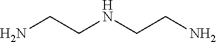 |
| propane-1,3-diamine | 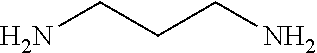 |
| butane-1,4-diamine | 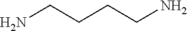 |
| pentane-1,5-diamine | 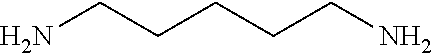 |
| pentylamine | 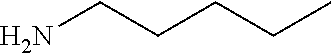 |
| propane-1,2-diamine | 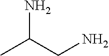 |
| spermine | 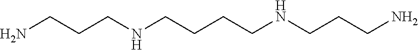 [SMILES: NCCCNCCCCNCCCN] |
| spermidine | 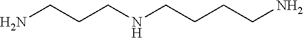 |
| 2,2-dimethylpropane-1,3- diamine | 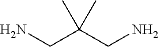 |

In some embodiments, the synthetic plastic polymer is polyethylene terephthalate (PET), polycarbonate (PC), or a blend with one or more polymers including polypropylene (PP), low-density polyethylene (LDPE), high-density polyethylene (HDPE), polyesters, polyamide, polystyrene (PS), or a mixture thereof. In some embodiments, the composition comprises a mixture of two or more synthetic plastic polymers, such as PET, PP, LDPE, HDPE, polyester, polyamide, PS, and/or PC.

In some embodiments, the polyester is a polycyclohexylenedimethylene terephthalate (PCT)

In some embodiments, the polyester is a polybutylene terephthalate (PBT).

In some embodiments, the amine is produced by a microbe, such as a bacterium, such as an Actinobacteria (or Actinomycetota), such as Actinoplanes deccanensis and Streptomyces euryhalinus. In some embodiments, the amine is produced by an Actinoplanes species cell. In some embodiments, the amine is produced by a Streptomyces species cell.

This invention discloses the dissolution and depolymerization of plastics, such as synthetic plastics, namely PET, PP, LDPE, HDPE, polyester, polyamide, PS, and PC at room temperature (and or lower temperature) in halogen-free, catalyst-free, inexpensive, and bio-compatible solvents such as amines (such as produced by an actinobacteria, such as Actinoplanes deccanensis or Streptomyces euryhalinus).

Preliminary results indicated that a high depolymerization (up to about 95%) of PET can be achieved in ethylenediamine at room temperature to generate N,N-bis(2-aminoethyl) terephthalamide. PET is also soluble in 1,2-propanediamine and 1,3-propanediamine at room temperature. Interestingly, the room temperature treatment of PET in 1,3-propanediamine led to an about 92% isolated yield of N,N-bis(2-aminopropyl) terephthalamide, a water-soluble product. The solubility trials are extended to other plastics such as PUR, PC, PS, PP, LDPE, and HDPE. While PC was completely soluble in ethylenediamine, PUR had limited solubility. Plastics with C—C backbone such as PP, PS, and PE had limited solubility in ethylenediamine at room temperature.

The dissolution and subsequent depolymerization of commercial plastic blends including PP, polyesters, and polyamide was also achieved with an about 20% mass loss into a water soluble amide product. The process, thereby, can be used to sort and separate the C—C backbone plastics from polyesters, polycarbonates, or the like.

The potential uses are in plastic waste management that is the process can be used to sort and separate the CC backbone plastics from polyesters, polycarbonates, etc. In some embodiments, the generation of potential monomers can lead to various new chemicals or materials.

The present invention has one or more of the following advantages: (1) Lower or no impact of contaminants on the process. (2) Lower energy input. (3) Demonstrated for mix plastic stream. (4) Greater reliability. (5) sorting of plastic while upcycling of waste into high-value aramid monomers.

Aramids are high performance polymers. They are used in industrial construction, aerospace, and military applications as heat and pressure resistant materials. The 2020-2025 market size is estimated to be $6 billion (with an annual growth of about 8%). It is expensive due to the costs associated with the raw materials. Semi-aramid compounds have both aromatic and aliphatic moieties, and have unique properties.

The present invention provides for a composition comprising: (a) a plastic polymer, and (b) an amine solvent compound; wherein the composition is halogen or halide free. In some embodiments, the composition has a temperature equal to or greater than about 25° C. or room temperature. In some embodiments, the composition has a temperature equal to or greater than about room temperature, 25° C., 30° C., 35° C., 40° C., 45° C., 50° C., or 55° C., or within a range of temperature between any two preceding values.

In some embodiments, the amine solvent comprises water. In some embodiments, the amine solvent is free of water.

The present invention provides for a method for depolymerizing a mixture of plastics, said method comprising: (a) providing a composition comprising a plastic polymer; (b) introducing an amine solvent compound to the composition to form a polymer-amine solvent composition, and (c) incubating the polymer-amine solvent composition for a period of time to produce a depolymerized composition such that at least a portions of the plastic polymer is depolymerized into a monomer(s) or a product that can be used for impact and heat resistant polymers.

The present invention provides for a method to dissolve a plastic, the method comprises: introducing or mixing an amine-based solvent, or a mixture thereof, to or with a plastic, or a mixture thereof, in the presence of absence of water, optionally at a given temperature and for a period of time. In some embodiments, the amine-based solvent is a Brønsted or Lewis base, wherein the amine-based solvent is a hydrogen bond donor and/or acceptor.

In some embodiments, the introducing or mixing step comprises at least part of the introducing or mixing step takes place where the temperature is from about 4° C. to about 120° C. In some embodiments, the introducing or mixing step, and/or the incubating step, takes place where the temperature is from about 4° C., 10° C., 20° C., 30° C., 40° C., 50° C., 60° C., 70° C., 80° C., 90° C., 100° C., 110° C., or 120° C., or a range of any preceding two temperatures. In some embodiments, the temperature is at room temperature, or from about 20° C. to about 30° C. In some embodiments, the introducing or mixing step comprises incubating from about 1 h to about 28 h, or about 1 h, 2 h, 4 h, 6 h, 8 h, 10 h, 12 h, 14 h, 16 h, 18 h, 20 h, 22 h, 24 h, 26 h, or 28 h, or a range of any preceding two time periods. In some embodiments, wherein the introducing or mixing step produces a water-soluble product. In some embodiments, the method further comprising incubating the polymer-amine solvent composition for a period of time to produce a depolymerized composition thereby at least a portion of the plastic polymer is depolymerized into monomers, such as monomers suitable for producing an aramid or semi-aramid, or a mixture thereof.

In some embodiments, the plastic polymer is (1) PET, or (2) blend or mix of polyamide, polypropylene, and PET. In some embodiments, the amine solvent compound is ethanediamine, propanediamine, hexanediamine, or 1,4-phenylenediamine. In some embodiments, the monomer or product is a “Product” indicated in FIG. 7. In some embodiments, the monomer or product is compound 4a, compound 4b, compound 4c, compound 4d, or compound 5a. In some embodiments, the PET is a PET flake. In some embodiments, the yield of the monomer or product is about any percent yield indicated in FIG. 7, or a value within a range of any two preceding values.

In some embodiments, the plastic polymer comprises about 0.1%, 0.5%, 1.0%, 1.5%, 2.0%, 2.5%, 5%, 10%, 15%, 20%, 25%, 30%, 35%, 40%, 45%, or 50% (wt %) of the plastic polymer, or a value within a range of any two preceding values. In some embodiments, the polymer-amine solvent composition comprises about 10%, 20%, 30%, 40%, 50%, 60%, 70%, 80%, 90%, 95%, 96%, 97%, 98%, or 99% (wt %) of the amine solvent compound, or a value within a range of any two preceding values. In some embodiments, the polymer-amine solvent composition comprises about 0%, 10%, 20%, 30%, 40%, 50%, 60%, 70%, 80%, or 90% (wt %) of water, or a value within a range of any two preceding values.

In some embodiments, the monomer(s) comprises one or more amino groups. In some embodiments, the monomer(s) comprises one or more aryl groups. In some embodiments, the monomer has one of the following structures:

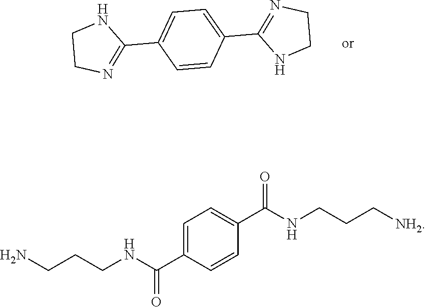 [SMILES: c1cc(C2=NCCN2)ccc1C1=NCCN1 ; NCCCNC(=O)c1ccc(C(=O)NCCCN)cc1]

In some embodiments, the composition is halogen or halide free. In some embodiments, the method further comprises: introducing an ionic liquid to the composition or polymer-amine solvent composition. In some embodiments, the method further comprises: (d) separating the monomer from the depolymerized composition. In some embodiments, the incubating step comprises incubating the polymer-amine solvent composition for a period of time at a temperature equal to or greater than about room temperature, 25° C., 30° C., 35° C., 40° C., 45° C., 50° C., or 55° C., or within a range of temperature between any two preceding values. In some embodiments, the composition and/or polymer-amine solvent composition has a temperature equal to or greater than about room temperature, 25° C., 30° C., 35° C., 40° C., 45° C., 50° C., or 55° C., or within a range of temperature between any two preceding values.

In some embodiments, the polymer used is end-of-life consumer product including textiles, bottles, and the like.

In some embodiments, the period of time is equal to or more than about 1 minute, 5 minutes, 10 minutes, 20 minutes, 30 minutes, 40 minutes, 50 minutes, 1 hour, 2 hours, 3, hours, 4 hours, 5 hours, or 6 hours.

In some embodiments, the incubating step produces a yield of equal to or more than about 5%, 10%, 20%, 30%, 40%, 50%, 60%, 70%, 80%, 90%, 95%, 98%, 99%, or 100% of the plastic depolymerized.

In some embodiments, the monomer obtained is water soluble.

In some embodiments, the amine solvents are volatile facilitating the solvent recovery/reuse.

In some embodiments, the method further comprises: producing an amine by culturing or growing a microbe that produces an amine or a mixture thereof, or a mixture of microbes wherein at least two or more microbes produce one or more different amines, such that the mixture of microbes produces a mixture of different amines; and providing the amine solvent comprising the amine produced by the producing step. In some embodiments, the microbe is an Actinobacteria (or Actinomycetota), such as Actinoplanes deccanensis and Streptomyces euryhalinus, an Actinoplanes species cell, or a Streptomyces species cell. In some embodiments, the providing step comprises mixing the amine or mixture of amines with one or more non-amine solvent compounds.

In some embodiments, the method further comprises: separating all, substantially all, or at least part of the monomers from the depolymerized composition, and optionally the monomers are used to polymerize into an aramid, such as KEVLAR® (Dupont Polymers, Inc., Wilmington, DE) and/or a meta-aramid, such as NOMEX® and/or a semi-aramid.

In some embodiments, the monomer comprises one or more amino group, and the method further comprises: introducing a carboxylic acid to the produced or separated monomer, and/or polymerizing the monomer and the carboxylic acid compound via melt-polycondensation into a polyamide, such as an aramid and/or semi-aramid, or a mixture thereof. In some embodiments, the produced amine (or monomer) undergoes melt-polycondensation with a carboxylic acid compound to polymerize into a polyamide, such as an aramid and/or semi-aramid, or a mixture thereof. In some embodiments, the method further comprises: polymerizing the amine (or monomer) and a carboxylic acid compound via melt-polycondensation into a polyamide. In some embodiments, the polyamide is an aramid and/or semi-aramid, or a mixture thereof. FIG. 6 shows a representative scheme depicting the formation of various polyamides (polyphthalamides and aramids) from PET using aminolysis with various amines.

In some embodiments, the carboxylic acid compound comprises or consists of carboxyl groups are not covalently bonded to the same carbon atom. In some embodiments, the carboxylic acid compound is a straight, branched, or cyclic alkane or aromatic with about 1, 2, 3, 4, 5, 6, 7, 8, 9, or 10 carbon atoms (in addition to any carbon atoms in the aryl group(s)), and about 1, 2, 3, 4, 5, 6, 7, 8, 9, or 10 carboxyl functional groups, or a mixture thereof. In some embodiments, the carboxylic acid compound is a straight or branched chain alkane, or a mixture thereof. In some embodiments, the carboxylic acid compound is an alkane with about 1, 2, or 3 carboxyl groups, or a mixture thereof.

The present invention provides for compositions and methods described herein. In some embodiments, the compositions and methods further comprise steps, features, and/or elements described in U.S. Patent Provisional Application Ser. No. 63/370,587, PCT International Patent Application No. PCT/US2023/029644, and U.S. Patent Application Publication No. 2020/0283415, hereby incorporated by reference in their entireties.

The present invention provides for compositions and methods described herein. In some embodiments, the compositions and methods further comprise steps, features, and/or elements described in U.S. Patent Provisional Application Ser. No. 63/124,660, and U.S. Patent Application Publication No. 2022/0194877, hereby incorporated by reference in their entireties.

The invention uses an amine solvent compound to depolymerize plastics into monomers, and optionally the monomers can be polymerized, optionally with another compound, into a polymer. The method allows the chemical recycling of plastics and their mixture.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 shows the production of

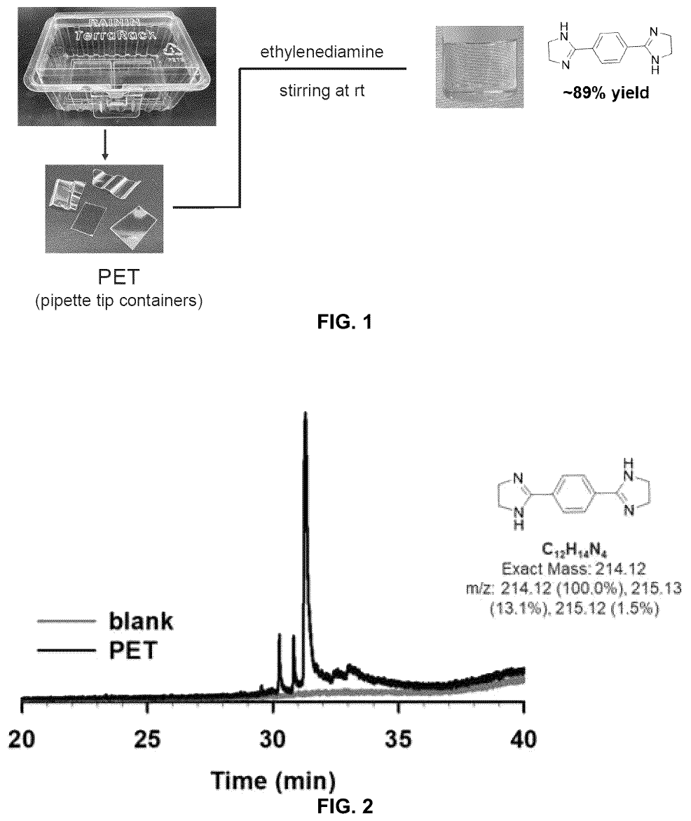

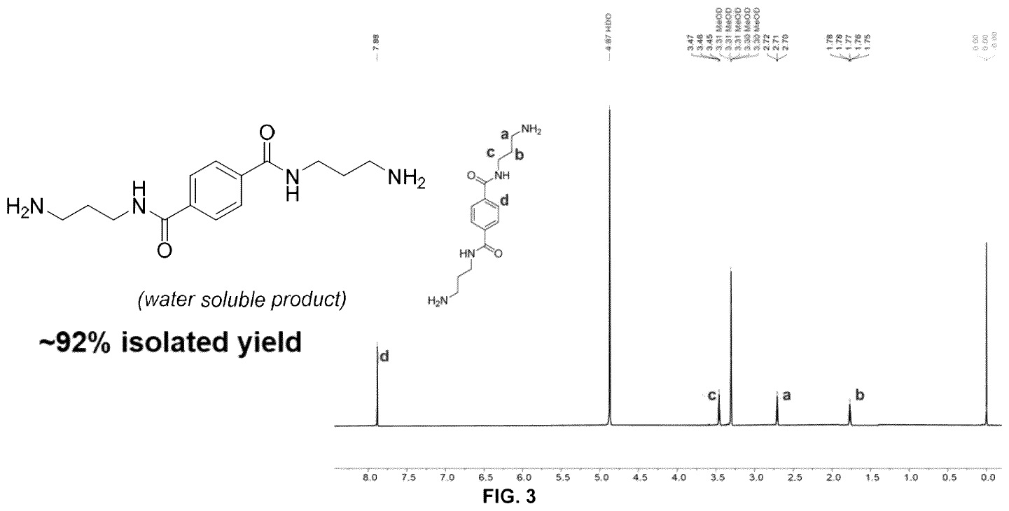

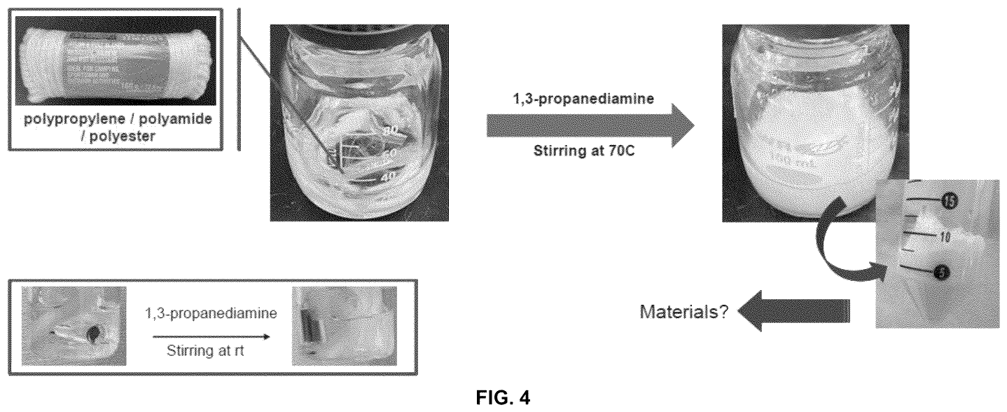

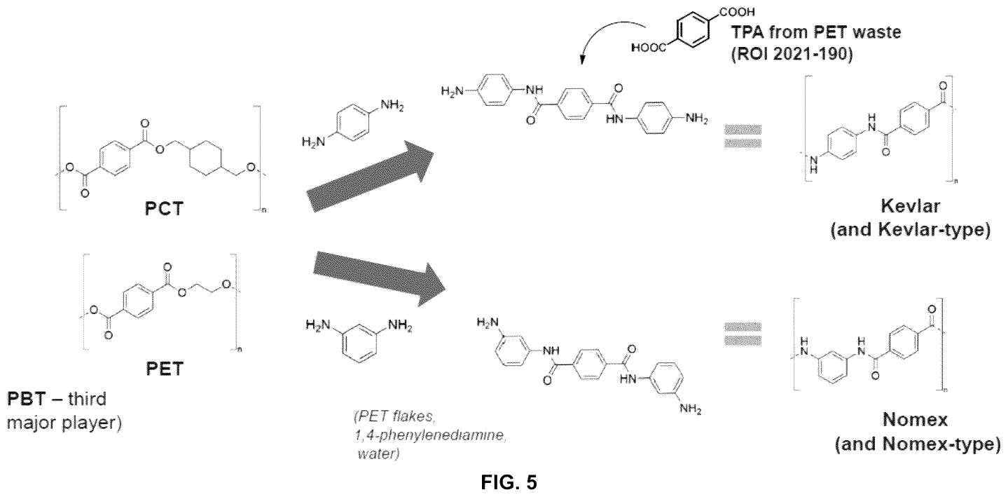

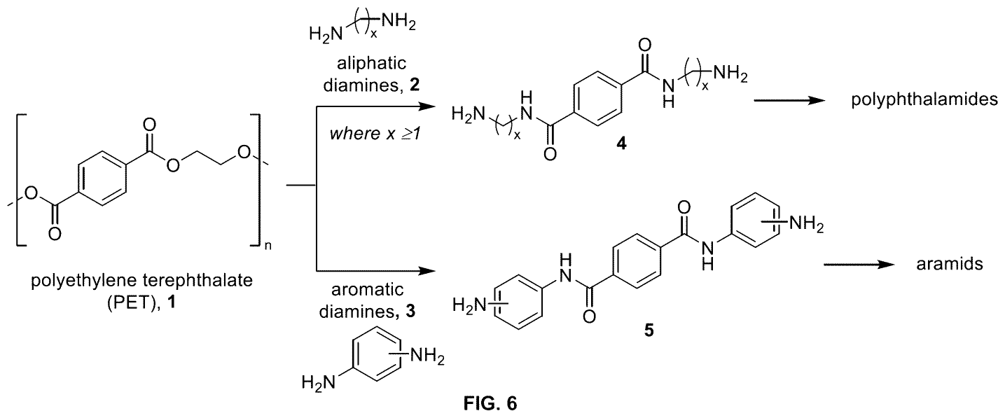

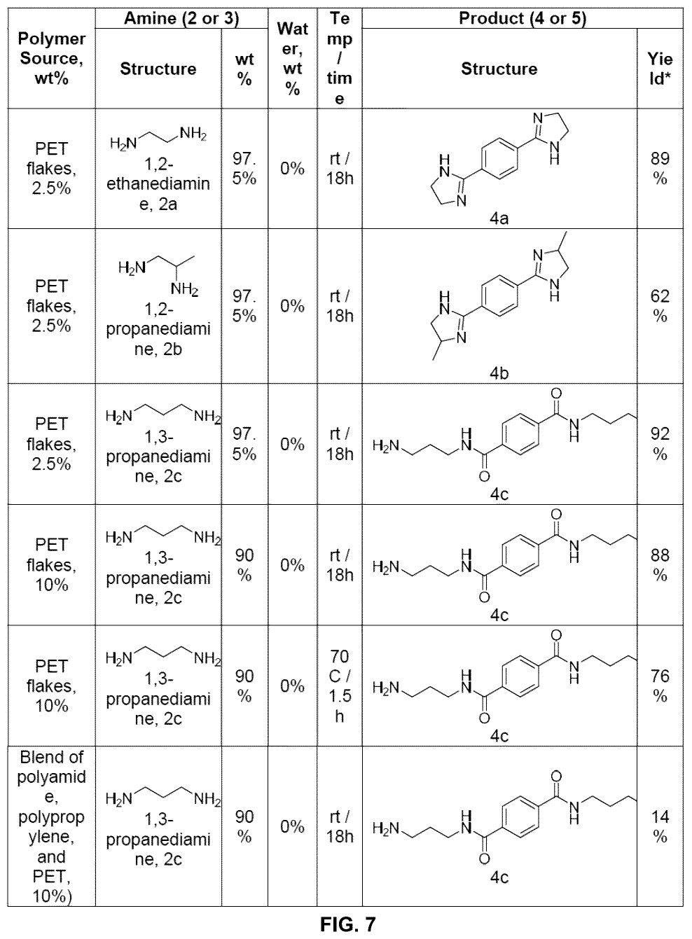

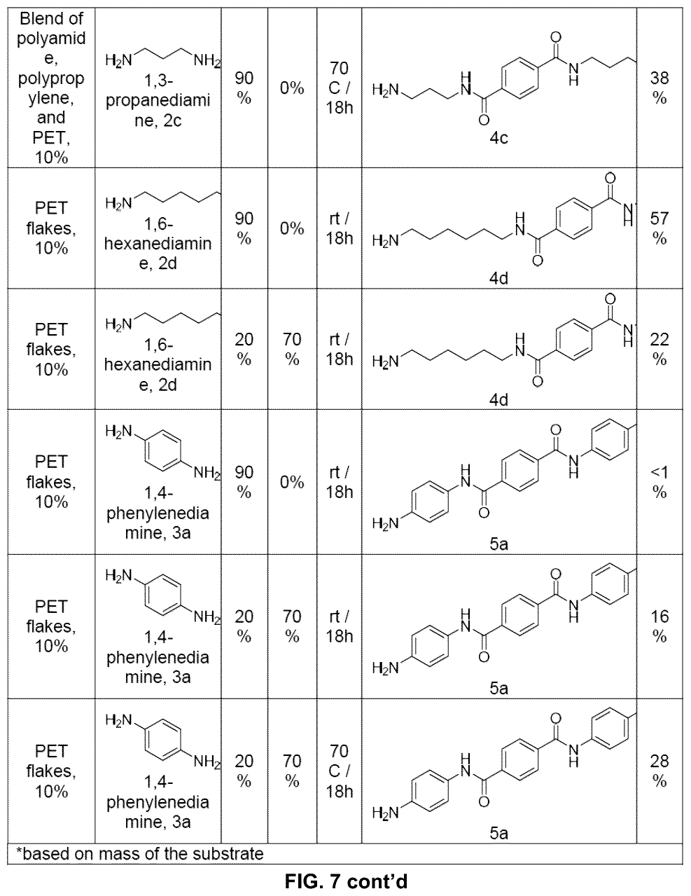

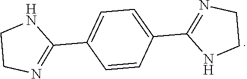 [SMILES: c1cc(C2=NCCN2)ccc1C1=NCCN1]

Stirring PET with ethylenediamine at room temperature produces about 89% yield of

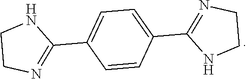 [SMILES: c1cc(C2=NCCN2)ccc1C1=NCCN1]

FIG. 2 shows the relative amount of

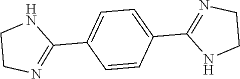 [SMILES: c1cc(C2=NCCN2)ccc1C1=NCCN1]

produced.

FIG. 3 shows the production of

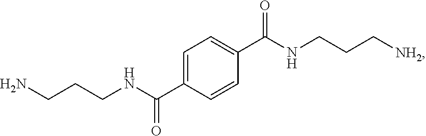 [SMILES: NCCCNC(=O)c1ccc(C(=O)NCCCN)cc1]

a water soluble product having a yield of about 92%.

FIG. 4 shows the stirring of polypropylene/polyamide/polyester with 1,3-propanediamine at about 70° C. or room temperature.

FIG. 5 shows a process for converting polymers, such as PCT and/or PET (which are the two most abundant polyesters in landfills), through depolymerization and conversion to another polymer, such as KEVLAR® (Dupont Polymers, Inc., Wilmington, DE) and/or a meta-aramid, such as NOMEX® (E.I. du Pont de Nemours and Company, Wilmington, DE).

FIG. 6 shows a representative scheme depicting the formation of various polyamides (polyphthalamides and aramids) from PET using aminolysis with various amines.

FIG. 7 shows products obtained after aminolysis using various amines.

### DETAILED DESCRIPTION OF THE INVENTION

Before the invention is described in detail, it is to be understood that, unless otherwise indicated, this invention is not limited to particular sequences, expression vectors, enzymes, host microorganisms, or processes, as such may vary. It is also to be understood that the terminology used herein is for purposes of describing particular embodiments only, and is not intended to be limiting.

In this specification and in the claims that follow, reference will be made to a number of terms that shall be defined to have the following meanings:

The terms “optional” or “optionally” as used herein mean that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “about” when applied to a value, describes a value that includes up to 10% more than the value described, and up to 10% less than the value described.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

### Amines

Amines are low-cost materials and when used for plastic recycling contribute to providing an overall economical process. Further, amines may be recycled during recycling thereby increasing the efficiency and economy of the present methods.

Suitable amines for this invention are selected from the group consisting of alky, alkenyl, aryl amines with mono-, di-, or multi-amine functional groups. The concentration of these amines, according to the present method, maybe from about 1% to 99% of the dry plastics.

The amines employed herein have a combination of electron releasing, steric and H-bonding factors that influence the stability of the substituted ammonium cations in protic polar solvents, affecting the basic nature of amines (pKa), and affecting their activity as nucleophiles.

Amines are strong bases owing to electron donation to the amine nitrogen by the carbon-chain/cycle, and consist of primary amines (R—NH₂), secondary amines (R—N—R′) and tertiary amines where R is an alkyl, alkenyl, allyl, or aryl chain. Specifically, R could be selected from a group consisting of a monovalent, divalent or trivalent 1-10 carbon alkane, alkene or alkyne, linear, branched, cyclic or aromatic. Examples of alkylamines include, mono, di- and tri-methylamine, mono, di- and tri-ethylamine, mono, di- and tri-propylamine, mono, di- and tri-butylamine. Alkylamines include mono-, di- and tri-amines, alcohol amines (HO—R—NH₂), diolamines ((HO)₂—R—NH₂), alcohol diamines (HO—R—(NH₂)₂), thiolamines (HS—R—NH₂), dithiolamines ((HS)₂—R—NH₂), thioldiamines (HS—R—(NH₂)₂) and alcohol thiolamines (H₂N—R(OH)(SH) where R is as defined.

Amines are also strong nucleophiles with pKas around 9-11.

### Example 1

### Dissolution and Depolymerization of Plastics

This study demonstrates the feasibility of applying amines in the chemical recycling of PET and polyesters in the presence or absence of water.

In this example, we investigated the aminolysis of PET using different amines in the presence or absence of water. In particular, the work focused on the aminolytic depolymerization of PET at room temperature without using any catalyst. After obtaining the highest depolymerization efficiency and product yields, the obtained product, aromatic amide molecule, could be re-polymerized to obtain aramids or semi-aramids.

Typically, PET flakes as itself or blended mixture with other polymers were mixed with amines or aqueous amines and stirred for a given time at a given temperature as explained below.

Aminolysis with Neat Aliphatic Amines

Polymer or their blends (2.5-10 wt %) and neat aliphatic amines (90-97.5 wt %) are mixed together in a glass vial containing glass or Teflon coated magnetic stir bar. The mixture is allowed to stir at room temperature (or 70° C.) for up to 18 hr. After the passage of a pre-determined time, a solid liquid separation is performed to remove any liquid (if any). The solids ae washed with water or tetrahydrofuran to dissolve any remaining product. The liquid layer is dried to obtain solid product, which is then weighed and analyzed using NMR or GC-MS to identify products.

Aminolysis with Aqueous Aliphatic Amines

Polymer or their blends (10 wt %), aliphatic amines (20 wt %), and water (70 wt %) are mixed together in a glass vial containing glass or Teflon coated magnetic stir bar. The mixture is allowed to stir at room temperature (or 70° C.) for up to 18 hr. After the passage of a pre-determined time, a solid liquid separation is performed to remove any liquid (if any). The solids are washed with cold acidic water to dissolve any remaining product. The liquid layer is dried to obtain solid product, which is then weighed and analyzed using NMR or GC-MS to identify products.

Aminolysis with Aromatic Amines

Polymer (10 wt %), aliphatic amines (20 wt %), and water (70 wt %) are mixed together in a glass vial containing glass or Teflon coated magnetic stir bar. The mixture is allowed to stir at room temperature (or 70° C.) for up to 18 hr. After the passage of pre-determined time, a solid liquid separation is performed to remove any liquid (if any). The solids are washed with cold acidic water to dissolve any remaining product. The liquid layer is dried to obtain solid product, which is then weighed and analyzed using NMR or GC-MS to identify products.

It is to be understood that, while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A composition comprising: (a) a plastic polymer, or a mixture of different plastic polymers, (b) an amine solvent compound, and (c) water.

2. The composition of claim 1, wherein the composition is halogen or halide free.

3. The composition of claim 1, wherein the amine solvent compound is a primary amine, secondary amine, tertiary amine, quaternary amine, or a mixture thereof.

4. The composition of claim 1, wherein the amine solvent compound has about 1, 2, 3, 4, 5, 6, 7, 8, 9, or 10 carbon atoms, or is an organic compound having a number of carbon atoms within a range of any two preceding values.

5. The composition of claim 1, wherein the amine solvent compound has about 1, 2, 3, 4, 5, 6, 7, 8, 9, or 10 amine functional groups.

6. The composition of claim 1, wherein the amine solvent compound has 2 or more amine functional groups.

7. The composition of claim 6, wherein the amine functional groups are not covalently bonded to the same carbon atom.

8. The composition of claim 1, wherein the amine solvent compound has amine solvent compound is a straight, branched, or cyclic alkane or aromatic with about 1, 2, 3, 4, 5, 6, 7, 8, 9, or 10 carbon atoms, and about 1, 2, 3, 4, 5, 6, 7, 8, 9, or 10 amine functional groups, or a mixture thereof.

9. The composition of claim 1, wherein the amine solvent compound has amine solvent compound is an alkane with about 1, 2, 3, or 4 amine functional groups, or a mixture thereof.

10. The composition of claim 1, wherein the amine solvent compound is ethaneamine, 1,1-ethanediamine, 1,2-ethanediamine, 1-propaneamine, 2-propaneamine, 1,1-propanediamine, 1,2-propanediamine, 1,3-propanediamine, 2,2-propanediamine, 1,1,1-propanetriamine, 1,1,2-propanetriamine, 1,2,2-propanetriamine, 1,1,3-propanetriamine, 1,2,3-propanetriamine, 1-butaneamine, 2-butaneamine, 1,1-butanediamine, 1,2-butanediamine, 1,3-butanediamine, 1,4-butanediamine, 2,2-butanediamine, 2,3-butanediamine, 1,1,1-butanetriamine, 1,1,2-butanetriamine, 1,1,3-butanetriamine, 1,1,4-butanetriamine, 1,2,2-butanetriamine, 1,2,3-butanetriamine, 1,2,4-butanetriamine, 1,3,3-butanetriamine, 2,2,3-butanetriamine, 1,1,1,2-butanetetraamine, 1,1,1,3-butanetetraamine, 1,1,1,4-butanetetraamine, 1,1,2,2-butanetetraamine, 1,1,2,3-butanetetraamine, 1,1,2,4-butanetetraamine, 1,1,3,4-butanetetraamine, 1,1,3,3-butanetetraamine, 1,2,2,3-butanetetraamine, 1,2,2,4-butanetetraamine, 1,2,3,3-butanetetraamine, 1,2,3,4-butanetetraamine, 2,2,3,3-butanetetraamine, benzenamine (aniline), benzene-1,2-diamine (1,2-diaminobenzene or o-phenylenediamine (OPD), benzene-1,3-diamine (1,3-diaminobenzene or m-phenylenediamine (MPD)), benzene-1,4-diamine (1,4-diaminobenzene or p-phenylenediamine (PPD)), or a mixture thereof.

11. The composition of claim 1, wherein the amine solvent compound is polyamine having the chemical structure: 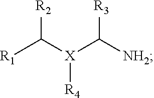
wherein X is CH or N; and R₁, R₂, R₃, and R₄, are each independently —H, —NH₂, alkyl, alkenyl, alkynyl, aryl, alkyl amine, alkenyl amine, alkynyl amine, or aryl amine.

12. The composition of claim 1, wherein the plastic polymer is a synthetic or natural polymer/polyester.

13. The composition of claim 1, wherein the plastic polymer is a polyethylene terephthalate, polybutylene terephthalate, polycyclohxanedimethylene terephthalate, polyethylene isophthalate, polycarbonate, or polylactic acid, or a mixture thereof.

14. The composition of claim 12, wherein the polyester is blended with polypropylene, polyethylene, polystyrene, polyurethane, or a mixture thereof.

15. The composition of claim 1, wherein the composition comprises: (a) a plastic, or mixture thereof, is present in the amount of from about 0.1% to about 70%; (b) an amine, or mixture thereof, is present in the amount of from about 10% to about 99.9%; and, (c) water is present in the amount of from about 0.01% to about 50%; wherein percentages are by weight or by volume.

16. A method for depolymerizing a mixture of plastics, said method comprising: (a) providing a composition comprising a synthetic plastic polymer; (b) introducing an amine solvent compound to the composition to form a polymer-amine solvent composition, and (c) incubating the polymer-amine solvent composition for a period of time to produce a depolymerized composition such that at least a portions of the synthetic plastic polymer is depolymerized into a monomer(s).

17. A method to dissolve a plastic, the method comprises: introducing or mixing an amine-based solvent, or a mixture thereof, to or with a plastic, or a mixture thereof, in the presence of absence of water, optionally at a given temperature and for a period of time.

18. The method of claim 17, wherein the amine-based solvent is a Brønsted or Lewis base, wherein the amine-based solvent is a hydrogen bond donor and/or acceptor.
